(19) United States
(12) Patent Application Publication
(10) Pub. No.: US 2012/0005018 A1
(43) Pub. Date: Jan. 5, 2012

(54) Large-Scale User Modeling Experiments Using Real-Time Traffic

(76) Inventors: Vijay Krishna Narayanan, Mountain View, CA (US); Rajesh Parekh, San Jose, CA (US); Albert Meltzer, Redwood City, CA (US); Sharon Y. Barr, Sunnyvale, CA (US); Nilesh Gohel, Fremont, CA (US); Utku Irmak, Santa Clara, CA (US); Feng Shao, Santa Clara, CA (US)

(21) Appl. No.: 12/830,259

(22) Filed: Jul. 2, 2010

(51) Int. Cl. G06Q 30/00; G06F 17/30; G06Q 10/00

(52) U.S. Cl. 705/14.52; 705/348; 707/736; 707/803; 707/E17.044

(57) ABSTRACT

A computer-implemented method for matching a display advertisement to a user within a large-scale, non-destructive user modeling and experimentation environment using real-time traffic. The method commences by populating a user profile object (containing demographics, history, and behaviors of the user) for use during concurrent operation of a production platform and an experimentation platform. To implement non-destructive testing, the method continues by cloning a portion of the real-time traffic for use by the experimentation platform while concurrently delivering the real-time traffic to the production platform. The production platform and the experimentation platform operate concurrently, scoring matches between the user profile objects and a plurality of display advertisements for selecting among the best-scored advertisements. At the conclusion of the experiment, a new user profile object is constructed by selecting a first portion of the experimentation user profile object for use during continued operation of the production platform. Any undesired data is discarded.

### FIELD OF THE INVENTION

The present invention is directed towards internet display advertising, more particularly to experimentation platforms for performing large-scale user modeling experiments using real-time traffic.

### BACKGROUND OF THE INVENTION

In an internet display advertising setting, testing new techniques for matching a user profile to an advertisement, as well as testing various experimental models of users, are areas of particular interest. Such new testing techniques seek to return experimental results while observing a non-destructive modeling and testing paradigm using actual real-time data and, in some cases, massive amounts of such actual real-time data. Consider that advertising over the internet seeks to reach individuals within a target set having very specific demographics (e.g. male, age 40-48, graduate of Stanford, living in California or New York, etc). This targeting of very specific demographics is in significant contrast to print and television advertisements that are generally capable only to reach an audience within some broad, general demographics (e.g. living in the vicinity of Los Angeles, or living in the vicinity of New York City, etc).

An advertiser may specify desired targeting criteria. For example, an advertiser may enter into a contract with the ad serving company, and the ad serving company may agree to post 2,000,000 impressions only to those individual who satisfy the desired targeting criteria. As becomes apparent throughout the disclosure herein, the aforementioned targeting criteria may be very specific. Moreover, making the determination as to whether or not a particular user satisfies some particular targeting criteria is an area of substantial ongoing interest.

Matching an advertisement to a user visit can be thought of as a market function, where a user visit is a unit of supply and an advertisement is a unit of demand. The market is served by matching supply to demand (or demand to supply). The matching of supply to demand applies to contextual advertising (e.g. text and graphical ads that match a page context and user impression) as well as to sponsored search advertising (e.g. ads that match with search engine queries and results). Various degrees of matching may occur when a user's attribute is matched against an advertiser's targeting criteria; moreover, a wide range of techniques for matching a user profile to an advertisement (e.g. demographic targeting, query-term matching, behavioral targeting, etc) might be employed in order to classify a user, and user interests, such that a match might be determined, thus completing the market function of matching available supply to available demand.

Consider:
The actual existence of a web page impression opportunity suited for displaying an advertisement is not known until a user clicks on a link pointing to the subject web page, and
A modern internet display advertising targeting system must handle a huge volume of such real-time events, and
The matching process for selecting advertisements must complete before the web page is actually displayed, and
All of the above must start and complete within a matter of fractions of a second.

It therefore becomes apparent that what is needed are techniques that enable large-scale user modeling experiments including experimentation using new matching techniques using real-time traffic.

Other automated features and advantages of the present invention will be apparent from the accompanying drawings and from the detailed description that follows below.

### SUMMARY OF THE INVENTION

Various models of users, their demographics, their history, their behaviors and interactions, and user adaptation effects within the context of a display advertising targeting environment are considered while pursuing non-destructive testing using actual, real-time data and, in some cases, massive amounts of such real-time data. Such a system includes a production platform and an experimentation platform. Various scoring techniques (which may differ between the production platform and the experimentation platform) serve for matching a display advertisement to a user. One method within such a system commences by populating a user profile object (containing demographics, history, etc of the user) for use during concurrent operation of a production platform and an experimentation platform. To implement non-destructive testing, the method continues by cloning a portion of the real-time traffic for use by the experimentation platform while concurrently delivering the real-time traffic to the production platform. The production platform and the experimentation platform operate concurrently through the duration of the experiment, and each system performs operations for scoring matches between the user profile object and display advertisements for subsequent selection from among the best-scored advertisements. At the conclusion of the experiment, a new user profile object is constructed by selectively retaining (e.g. merging) a portion of the user profile object for use during continued operation of the production platform. Any undesired data is discarded.

### BRIEF DESCRIPTION OF THE DRAWINGS

The novel features of the invention are set forth in the appended claims. However, for purpose of explanation, several embodiments of the invention are set forth in the following figures.

FIG. 1 depicts an advertising server network environment in which some embodiments operate.

FIG. 2 depicts an exemplary data structure showing one of a plurality of user profile objects, according to one embodiment.

FIG. 3A depicts a block diagram of a system for matching a display advertisement to a user within a large-scale, non-destructive user modeling and experimentation environment using real-time traffic, according to one embodiment.

FIG. 3B depicts a block diagram of a system for matching a display advertisement to a user within a large-scale, non-destructive user modeling and experimentation environment using real-time traffic, according to another embodiment.

FIG. 4A depicts an exemplary extensible data structure showing one of a plurality of modified user profile objects, according to one embodiment.

FIG. 4B depicts exemplary operations for initializing an extensible data structure and for merging a user profile object, according to one embodiment.

FIG. 5 depicts a block diagram of an extensible system for large-scale user modeling experiments using real-time traffic, according to one embodiment.

FIG. 6 depicts a block diagram of a method for matching a display advertisement to a user within a large-scale, non-destructive user modeling and experimentation environment using real-time traffic, according to one embodiment.

FIG. 7 depicts a block diagram of a method for large-scale user modeling experiments using real-time traffic, according to one embodiment.

FIG. 8 depicts a block diagram of a system to perform certain functions of an advertising server network, according to one embodiment.

FIG. 9 is a diagrammatic representation of a network including nodes for client computer systems, nodes for server computer systems, and nodes for network infrastructure, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### Section I: Introduction

Techniques for determining if a particular user satisfies an advertiser's specific targeting criteria is an area of substantial interest, and the aforementioned targeting criteria may be very specific. Improvements to display advertising, in particular improvements to ad targeting may employ models of users, models of user demographics, models of user behaviors and models of interactions and user adaptation. Such models might come in the form of rules and/or algorithms, and acts subsumed under the rubric of modeling may involve substantial calculations, mathematics, and computing resources of various kinds

More particularly, some modeling techniques are best evaluated using actual, real-time data and, in some cases, massive amounts of such real-time data, which such massive amounts of real-time data might only be available from a fully operational commercial production platform. For example, many deployments of fully operational commercial systems rely on large databases that have been assembled over a long period of time, and/or calculated using massive computing resources. Large-scale modeling experiments rely not only on the existence of such aforementioned large databases, but also rely on the acts of carrying out experiments that may write to, or otherwise modify, such large databases. However, since the goodness of the model, and/or the success of the experiment, may not be known until after performing the modification of the large databases, performance of an experiment risks polluting the large databases with experimental data. That is to say, performance of an experiment risks polluting a large database used in a production platform with experimental data of unknown value. Moreover, the experimental data might possibly be polluting to a high degree. Thus, a robust, scalable and extensible experimentation platform is desired for large scale modeling.

Challenges in designing such a platform include: 1) rapid development, testing, and deployment; 2) the ability to handle large-scale real-time traffic with low latency and high throughput; 3) flexibility to carry out multiple experiments concurrently using varied configurations; 4) integrating user profiles (e.g. cookies) built online and offline; 5) efficient online journaling to provide sufficient insights to improve the experiments; and 6) the ability to perform experiments using production data, yet resulting in no impact, or low impact, on the production data as a result of performing experiments.

Embodiments disclosed herein include an experimentation platform (sometimes termed a display advertising experimentation platform, or an ad matching experimentation platform) that addresses the challenges described above. Although the herein disclosed display advertising targeting experiment platform might be used for a broad array of experiments, the examples herein are related to experimentation with display advertising models that are designed to predict (among other things) a user's propensity to click on a display ad given a certain set of conditions. The proposed systems and methods will enable rapid configuration of, and non-destructive execution of, experiments for testing multiple models and model scenarios, using both real-time traffic and portions of production data.

In the context of systems and methods for large-scale user modeling experiments using real-time traffic, exemplary embodiments are non-destructive and non-invasive; in other words, non-destructive in the sense that the act of performing an experiment is intended to be a non-destructive act with respect to production data, and non-invasive in the sense that any operations that would normally occur in a production platform (i.e. would occur in a production platform even in the absence of any concurrent experiment) as a normal consequence of the real-time traffic (e.g. page views, user clicks, etc) are not changed by the concurrent running of experiments on the experimentation platform.

The notion of a production platform includes an advertising server network in an operational, real-time internet environment, with real users requesting web pages—and clicking on links and advertisements—and expecting real-time responses from the internet. Similarly, the notion of an experimentation platform also includes an advertising server network in an operational, real-time internet environment, with real users requesting web pages—and clicking on links and advertisements—and expecting real-time responses from the internet.

### Production Platform Overview

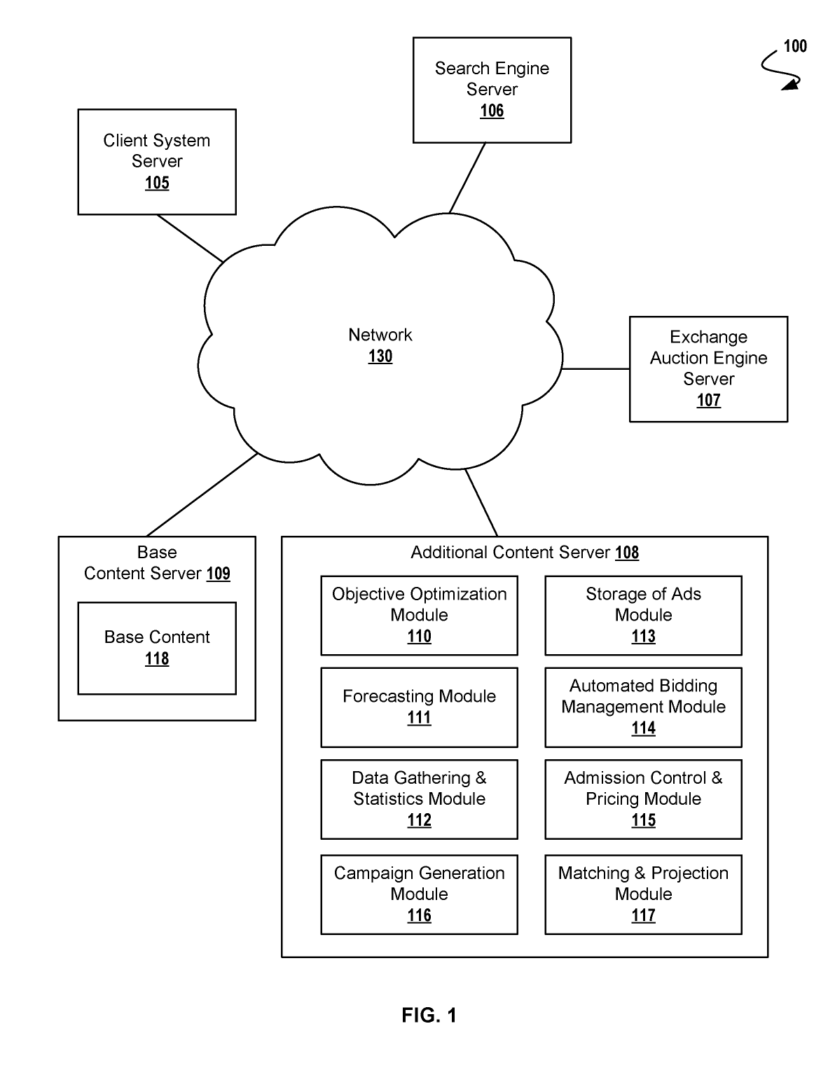

FIG. 1 depicts an advertising server network environment in which some embodiments operate. In the context of internet advertising, placement of advertisements within an internet environment (e.g. system 100 of FIG. 1) has become common. By way of a simplified description, an internet advertiser may select a particular property (e.g. Yahoo.com/Finance, or Yahoo.com/Autos), and may create an advertisement such that whenever any internet user, via a client system server 105 renders the web page from the selected property, the advertisement is composited on the web page by one or more servers (e.g. a base content server 109, an additional content server 108) for delivery to a client system server 105 over a network 130. Given this generalized delivery model, and using techniques disclosed herein, sophisticated online advertising might be practiced. More particularly, an advertising campaign might include highly-customized advertisements delivered to a user corresponding to highly-specific demographics. Again referring to FIG. 1, an internet property (e.g. an internet property hosted on a base content server 109) might be able to measure qualities or quantities of visitors that have any arbitrary characteristic, demographic or attribute, possibly using an additional content server 108 in conjunction with a data gathering and statistics module 112. Thus, an internet user might be ‘known’ in quite some detail as pertains to a wide range of demographics or other attributes.

Therefore, multiple competing advertisers might enter into a display advertisement contract, and/or elect to bid in a market (e.g. an exchange) via an exchange server or auction engine 107 in order to place the advertisement in the most prominent spot in a web page.

In embodiments of the system 100, components of the additional content server perform processing such that, given an advertisement opportunity (e.g. an impression opportunity profile predicate), processing determines which (if any) contracts match the advertisement opportunity. In some embodiments, the system 100 might host a variety of modules for searching (e.g. search engine server 106) and/or to serve management and control operations (e.g. an objective optimization module 110, a forecasting module 111, a data gathering and statistics module 112, a storage of advertisements module 113, an automated bidding management module 114, an admission control and pricing module 115, a campaign generation module 116, a matching and projection module 117, etc) pertinent to contract matching and delivery methods. In particular, the modules, network links, algorithms, and data structures embodied within the system 100 might be specialized so as to perform a particular function or group of functions reliably while observing capacity and performance requirements. For example, an additional content server 108, possibly in conjunction with an auction engine 107 might be employed to define and prosecute a campaign.

As can be inferred from the foregoing, the definition and delivery of online display advertising has become more and more sophisticated in recent times, and techniques for matching users to advertisements are under continuous improvement. Accordingly, the proposed systems and methods will enable rapid configuration of, and non-destructive execution of, experiments for testing multiple models and model scenarios, using both real-time traffic and portions of production data in order to improve techniques for matching users to advertisements.

### Targeting Overview

Display advertising targeting may come in many forms. In the context of execution of an advertising campaign, an advertiser might want to address specific advertisements or messages to specific audiences (i.e. target audiences). These target audiences may be identified using a variety of techniques where such techniques may include use of an audience profile, possibly including a predicate such as “Residents of New York with at least three members in the household”. An audience profile might be used to select a group from among a large user base, such that the group selected matches the predicate. A set of attributes for a particular user might be stored within a data structure (e.g. a cookie, a user profile) and the logical sense of one or more target audience predicates can be used to match one or more users (e.g. by matching to the aforementioned attributes or attribute descriptors found in a user profile data structure). Attributes might be explicit, defined voluntarily by the corresponding user, or possibly one or more attributes might be inferred from other attributes or observed events. For example, a system for identifying a particular target audience might use one or more of the following attributes:
Targeting based on user-declared geography (e.g. zip code of residence)
Targeting based on observed geography (e.g. location of client platform)
Demographics (factual or virtual, declared or observed)
Search interests (factual or virtual, declared or observed)
Campaign responses (e.g. views, clicks)
Predictive behavioral interests

The particulars of any given attribute may be quite complex, and might correspond to complex models. For example, a user ‘interest’ might be static, in the sense that a user interest might be coded so as to correlate to some taxonomy (e.g. finance, sports, games, retail, etc); or a user ‘interest’ might be dynamic, in the sense that a user interest might be coded so as to correlate to some series of events (e.g. page view in finance, page view in sports, ad click in sports, etc). Moreover, a user ‘interest’ might be characterized as short-term, in the sense that a user interest might be fleeting; or a user ‘interest’ might be characterized as long-term, in the sense that a user interest might be coded so as to correlate to some series of events that occur, or attributes that remain true over a long period of time.

Modeling of such user attributes used in display advertising targeting might be codified into a data structure.

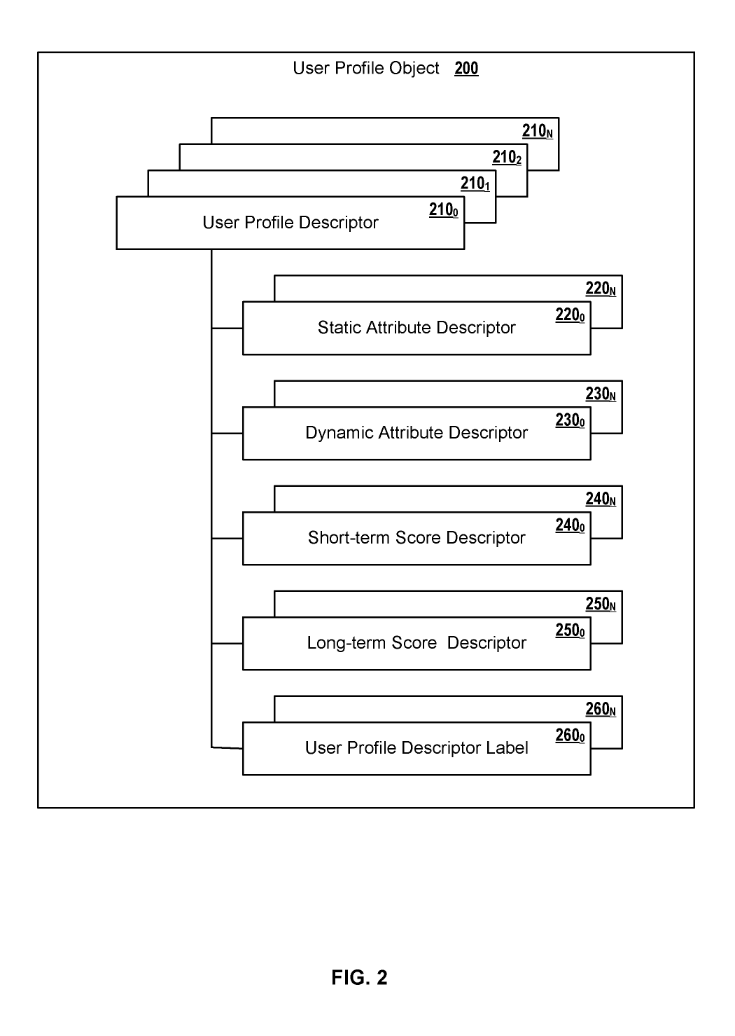

FIG. 2 depicts an exemplary data structure showing one of a plurality of user profile objects 200, according to one embodiment. An exemplary user profile object 200 might comprise one or more user profile descriptors 210₀-210_{N}, which in turn may contain or be associated with one or more static attribute descriptors 220₀-220_{N}, one or more dynamic attribute descriptors 230₀-230_{N}, one or more short-term score descriptors 240₀-240_{N}, one or more long-term score descriptors 250₀-250_{N} and one or more user profile descriptor labels 260₀-260_{N}.

A data structure, such as exemplified by user profile object 200, might be used in a display advertising modeling context. For example, a user profile object 200 might be used to store short-term scores that are calculated repeatedly at a relatively high frequency (e.g. daily), and a user profile object 200 might be used to store long-term scores that are calculated repeatedly at a relatively low frequency (e.g. weekly). Further, used in a display advertising targeting context, various forms of scores might be computed based on aspects of data found in a user profile object 200, such as aspects of recency and/or aspects of intensity. In one embodiment a score might be calculated according to:

$${s}_{i} = intercept + {\sum }_{event} {w}_{event} {i}_{event} + {\sum }_{event} {w}_{revent} {r}_{event}$$

where Sᵢ includes a value pertaining to recency and a value pertaining to intensity, and some intercept value. Selection of the specific events and weights might be used to compute a long-term Sᵢ score, or alternatively a selection of specific events and weights might be used to compute a short-term Sᵢ score. Moreover, over time, the attributes, characteristics, values and events may be calculated and/or stored by any display advertising targeting model.

### Display Advertising Targeting Model Development in a Non-Destructive Environment

As may be understood from the foregoing, there may be many specific events and weights that contribute to the calculation of any display advertising matching score. Particularly as refers to display advertising targeting model development, a trial or experiment involving a particular modeling technique might alter the attributes, characteristics, values and events as may be calculated and/or stored within a user profile object 200, and any display advertising targeting and matching model might change as the experiment progresses. Thus, a trial or experiment involving a user model or user modeling technique might possibly alter data within a user profile object 200 in an unwanted manner. Such an occurrence (i.e. of the altering of data within a user profile object 200 in an unwanted manner) is termed destructive testing.

In contrast, non-destructive techniques supporting experimentation are desired, and are disclosed herein. Moreover, a generalized experimentation framework is desired, and such a generalized experimentation framework may be defined such that the experimentation framework supports flexible, extensible and non-destructive testing of scoring approaches for ad targeting, where successful scoring approaches (e.g. for determining relevance) may be quickly integrated into a production environment. More specifically, the generalized experimentation framework disclosed herein includes facilities for:
Rapidly testing display advertising targeting scoring, and relevance scoring functions
Rapidly testing other scoring functions
Providing broad access to production platform data and events
Testing multiple experimental characteristics concurrently
Cloning or mapping of production stored data
Cloning or selection of production event data
Monitoring long-running experiments
Uploading data from the experimentation framework to the production platform

### Section II: System for Large-Scale User Modeling Experiments Using Real-Time Traffic

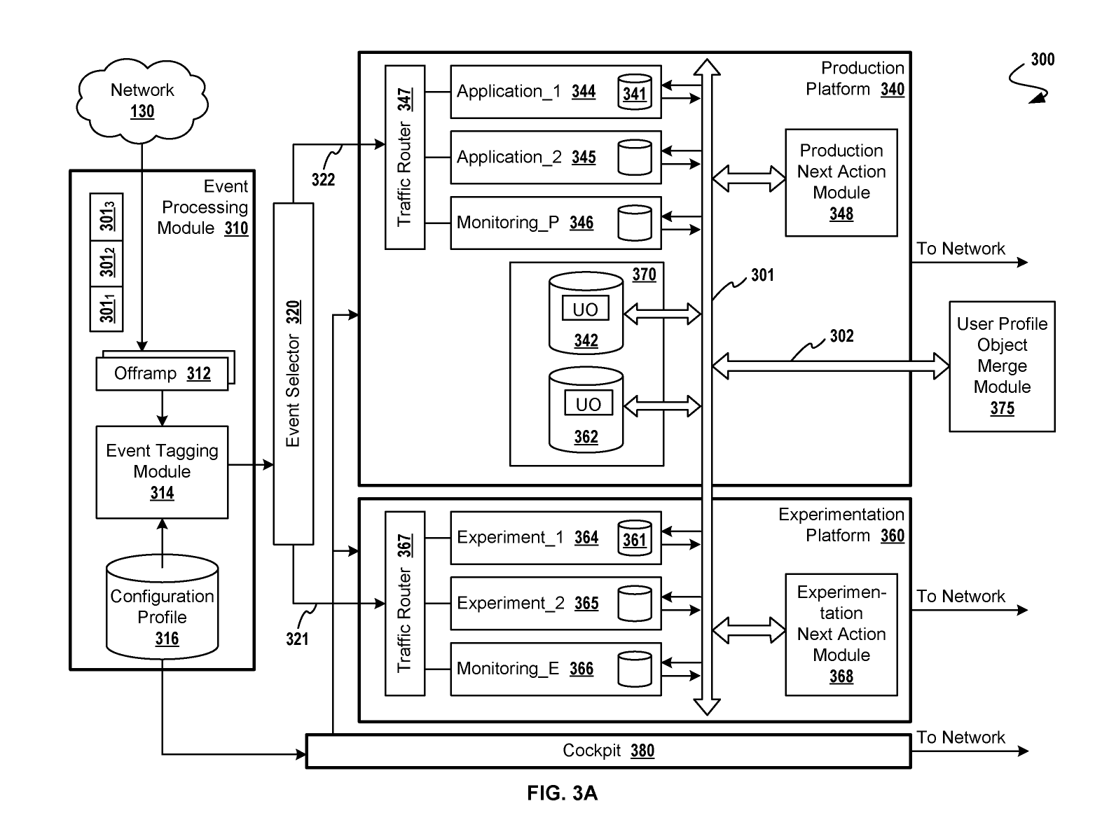

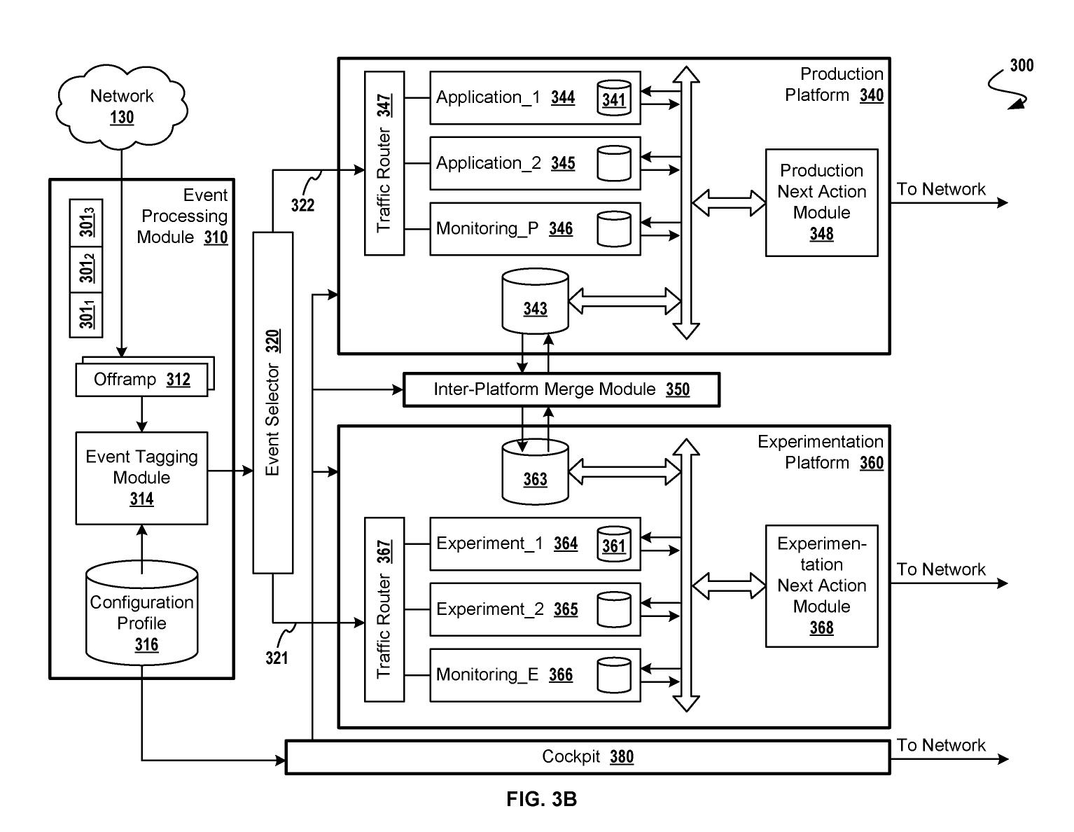

FIG. 3A depicts a block diagram of a system for matching a display advertisement to a user within a large-scale, non-destructive user modeling and experimentation environment using real-time traffic, according to one embodiment.

As an option, the present environment 300 may be implemented in the context of the architecture and functionality of the embodiments described herein. Of course, however, the environment 300 or any structure or operation therein may be carried out in any desired environment. The environment 300, together with constituent components as shown, serves for implementing a method for matching a display advertisement to a user within a large-scale, non-destructive user modeling and experimentation environment using real-time traffic. The environment 300, in particular, the production platform 340 (e.g. the production platform being a computer, or a network of computers, etc) in cooperation with a user profile object merge module 375 serve for populating user profile objects (e.g. production user object UO 342 and experimentation user object UO 362) for use during concurrent operation of the production platform 340 and the experimentation platform 360 (e.g. the experimentation platform being a computer, or a network of computers, etc). For dealing with real-time traffic (e.g. traffic over a network 130) within the experimentation environment, an event processing module 310, in cooperation an event selector 320, serves for cloning a portion of the real-time traffic for use by the experimentation platform while concurrently delivering said portion of the real-time traffic to the production platform. In this embodiment, the event processing module may select some portion of the total traffic received from network 130.

As shown, both the production platform 340 as well as the experimentation platform 360 serve for scoring matches (e.g. relevance scoring) between a user or a representation of a user (e.g. user profile object) and a plurality of display advertisements. For example, the production platform 340 might execute Application_{—}1 344 using a database comprising a plurality of display advertisements (e.g. display advertisement database 341), while concurrently, the experimentation platform 360 might execute Experiment_{—}1 364 and/or Experiment_{—}2 365 using a database comprising a plurality of display advertisements (e.g. display advertisement database 361). The display advertisement database 341 and the display advertisement database 361 might be the same database, or the display advertisement database 341 and the display advertisement database 361 might be different display advertisement databases.

Such experimentation might continue for any period of time, and at the conclusion of such experimentation, the user profile objects (e.g. UO 342 and UO 362) in a commonly accessible storage space 370 (e.g. storing UO 342 and UO 362) might be merged, possibly using inter-platform communication bus 301 and/or merge control bus 302. The user profile object merge module 375 serves for performing a merging operation on a first portion of a user profile object for use during continued operation of the production platform. Also, user profile object merge module 375 might serve for selecting a second portion of the user profile object for non-destructive discard.

In the manner of the embodiment shown in FIG. 3A and hereinabove described, it can be seen that such an embodiment implements a computer-implemented method for matching a display advertisement to a user within a large-scale, non-destructive user modeling and experimentation environment using real-time traffic.

Of course, selecting real-time events, and/or selecting data in the course of conducting an experiment, might involve a range of selection and configuration techniques. Moreover various techniques are used for performing user profile merge operations, and such techniques are further described below.

As shown, in FIG. 3A, environment 300 includes an event processing module 310, an event selector 320, a production platform 340, an experimentation platform 360, a user profile object merge module 375, and surrounding components. Exemplary operation of environment 300 can be understood as follows:
Users operating a client system 105 (see FIG. 1) interact with the internet via a network 130, which interaction produces events (e.g. event 301₁, 301₂, 301₃, etc) such as a request for a page from a server (e.g. from a base content server 109), or such as a click on an advertisement.
Events are received by an event processing module 310, which may use an offramp module 312 for sending events to an event tagging module 314, which in turn may take inputs from a configuration profile 316.
Selected events, after being parsed and possibly tagged by the event tagging module 314 are sent (with any tags) to an event selector 320.
An event selector 320 may then replicate or divert some portion (or none or all) of the incoming events to a production platform 340 and/or to an experimentation platform 360.
Depending on any configuration parameters (e.g. from configuration profile 316), and possibly depending on any aspects of any event processed through the event selector 320, a user profile object merge module 375 might commence to allocate and populate data structures (e.g. user profile objects), possibly using the UO 342 (which UO 342 is accessible to the production platform 340), and processing might continue, possibly running any one or more applications (e.g. Application_{—}1 344, Application_{—}2 345, etc).
The experimentation platform 360 processes events in parallel with the production platform 340, and such processing may trigger an experimentation next action module 368, which in turn can cause further events, possibly sent to the internet via network 130.
At some point in time, an experimenter might use the cockpit 380 to control the user profile object merge module 375, possibly causing a merge of data constituent to the UO 362 and to the UO 342.

### Display Advertising Targeting Using a System for Large-Scale User Modeling Experiments Using Real-Time Traffic

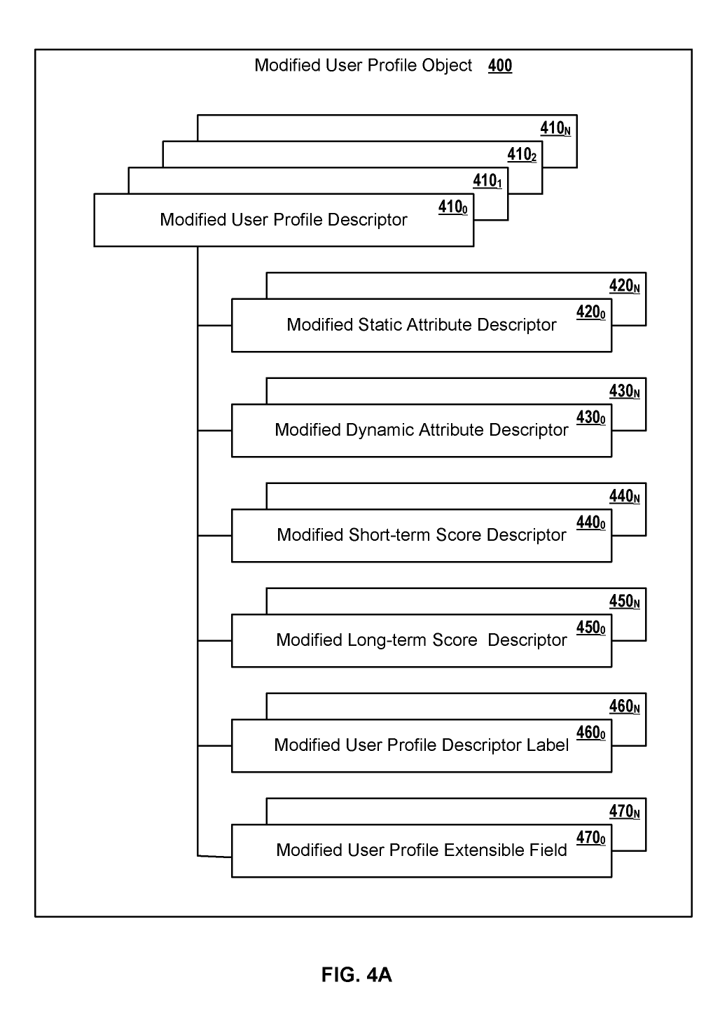

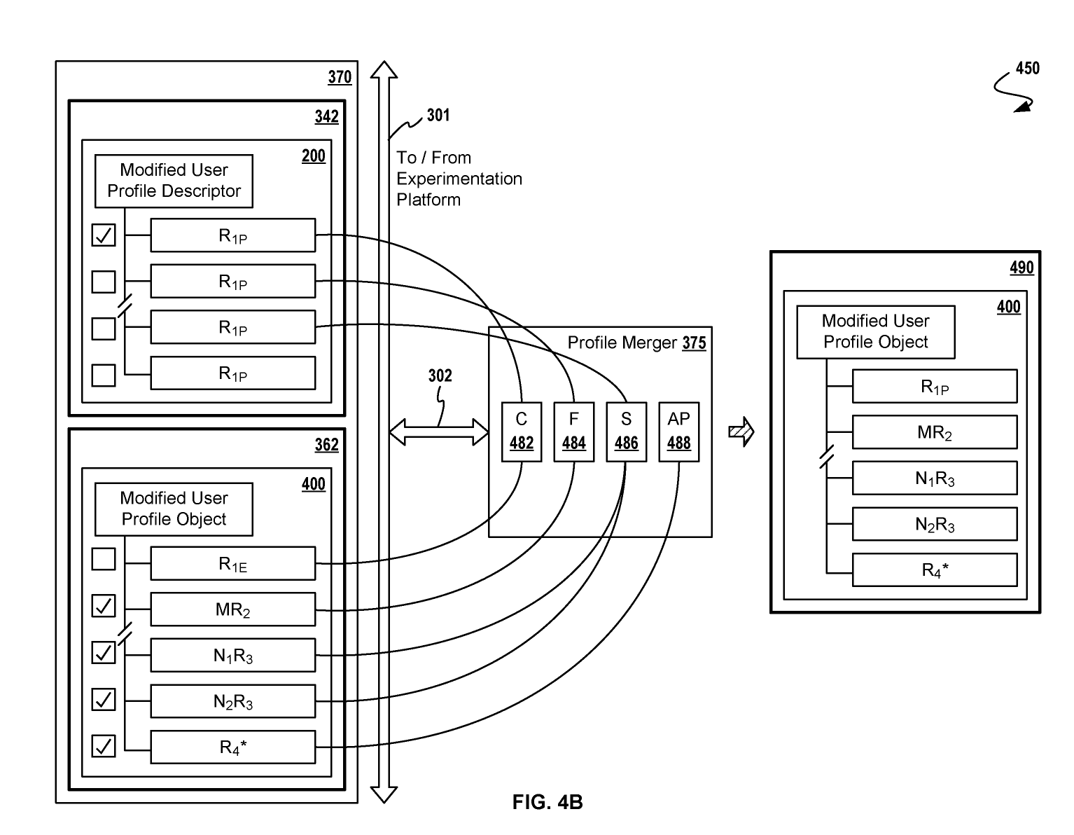

The environment 300 serves to facilitate experimental collaboration between a production platform and an experimentation platform. In exemplary operation, a set of user profile objects are selected for processing by the experimentation platform. The set of user profile objects may be selected at random, or there may be some particular criteria for selecting a particular user profile object. Given a selected user profile object, the real-time traffic that belongs to a selected user profile object may be diverted from the production platform traffic and instead may be directed into the experimentation platform, thus providing the experimentation platform with actual real-time user data. For some experiments to be performed on the experimentation platform, the real-time traffic that belong to a selected user profile object may be replicated from the production platform traffic, and such replicated traffic may then be directed into the experimentation platform. For some such experiments, it is sufficient to populate the UO 362 with data modeled after the UO 342 (see FIG. 4B). In other cases, the experiments are such that one or more user profiles need to be primed, that is, modified over some time by operation of the experimentation platform (or external process), so as to modify the UO 362 with incoming real-time traffic.

During an experiment, which may require days or weeks or longer, of real-time operation, user profile objects may be modified as a natural consequence of running the experiment. The progression of the experiment is monitored, possibly using cockpit 380, and an experimenter may determine to suspend or cease (or continue) the experiment. Or, an experimenter may determine that the experiment was successful, and the data (e.g. user profile data) should be made available to the production platform on an ongoing basis. In such a case, various output of the experimentation platform (e.g. the UO 362, as may be modified by the experimentation) are identified, and thus selected and merged.

It should be recognized that the experimentation platform and the production platform may cooperate in such a merging/transfer/synchronization of any sorts of data. In particular, one or more uploader modules may serve to perform buffering and/or aggregation operations so as to optimize the upload bandwidth usage. In some cases the any user profiles populated during the experimentation may be labeled so as to be distinguishable from the otherwise labeled (or possibly un-labeled) user profiles.

As earlier indicated, the progression of an experiment may be monitored and an experimenter may determine to suspend or cease the experiment. In such a case, the non-destructive aspects of the architecture of environment 300 are employed. Specifically, in the case of an experiment deemed as unsuccessful, the experimenter may merely halt the experiment as follows:
Signal the event selector 320 to direct the traffic formerly directed to the experiment to cease replication and/or redirection, and/or
Halt the experiment while performing only selected merging operations (e.g. directing a user profile object merge module 375 to discard polluted data), and/or
Halt the experiment without performing any merge of the UOs.

It should be noted that in the case that an upstream module (for example, an event selector 320) might have replicated traffic (see earlier descriptions of event selector 320)—i.e. the same traffic as was processed by the experimentation platform during the course of the experiment—that was also processed by the production platform, this would mean that the production platform datastore contains user profile objects that are in a state as would be stored had there been no experimentation platform processing at all. After the experiment is halted (as described above), the production platform will continue to process traffic using the (possibly merged or otherwise updated) user profile object(s). In this and other embodiments, the replication of user profile objects, in combination with the case of traffic replication, serves to facilitate choosing from among the choices of UO data at serving time. In fact, since an incoming event (e.g. an event received at the event tagging module 314) may be tagged, and such a tag may be carried with the event, a tag with such an event may be used for quickly switching between processing real-time events in the production platform versus processing real-time events in the experimentation platform.

Within the context of the production platform as heretofore described, and more particularly using display advertising targeting within an application (e.g. within Application_{—}1 344), a production platform may determine any number of next actions (e.g. display a particular advertisement, render a page view, etc), and a production next action module 348 may cause such action or actions to be carried out by sending events to the internet via network 130.

FIG. 3B depicts a block diagram of a system for matching a display advertisement to a user within a large-scale, non-destructive user modeling and experimentation environment using real-time traffic, according to one embodiment. As an option, the present environment 300 may be implemented in the context of the architecture and functionality of the embodiments described herein. Of course, however, the environment 300 or any structure or operation therein may be carried out in any desired environment. As shown, environment 300 includes an event processing module 310, an event selector 320, a production platform 340, an experimentation platform 360, and surrounding components, including a inter-platform merge module 350.

According to this embodiment, the production platform 340 and the experimentation platform 360 are virtual platforms, and the underlying hardware might be different (or might be the same) and/or the data storage are virtual data storage, and the underlying hardware might be different (or might be the same). Strictly for example, any components of the production platform 340 and/or the experimentation platform 360 might execute on, and/or be managed by a massively parallel distributed computing system (e.g. Hadoop).

Continuing the discussion of the embodiment of FIG. 3B, processing within this embodiment might employ an event selector 320, and/or a traffic router 347 for selecting, in a computer memory, a first set of user events (e.g. any of user events 301₁, 301₂, 301₃ etc) for processing by a production platform 340. Other steps might employ an event selector 320, and/or a traffic router 367 for selecting a second set of user events (e.g. any of user events 301₁, 301₂, 301₃ etc) for processing by an experimentation platform 360. Any one or more modules within a production platform 340 might be configured for extracting a baseline set of user profile objects, the baseline set of user profile objects being extracted from a production platform datastore 343, and copied to an experimentation platform datastore 363 and processing might continue, running any one or more applications (e.g. Application_{—}1 344, Application_{—}2 345, etc) concurrently with any one or more experiments (e.g. Experiment_{—}1 364, Experiment_{—}2 365). It should be noted that a datastore may comprise data in addition to the aforementioned user profile objects.

Further, an experimentation platform 360 might employ a traffic router 367, and/or any modules (e.g. Experiment_{—}1 364, Experiment_{—}2 365, etc) for processing the second set of user events using the baseline set of user profile objects. Within the context of the experimentation platform 360 as heretofore described, and more particularly using experimental display advertising targeting within an experiment, an experimentation platform may determine any number of next actions (e.g. display a particular advertisement, render a page view, etc), and an experimentation next action module 368 may cause such action or actions to be carried out by sending events to the internet via network 130. In the course of executing such experiments, any module within the experimentation platform might modify at least one bit of the baseline set of user profile objects to create a modified baseline set of user profile objects, possibly within an experimentation platform datastore 363.

In this embodiment, the inter-platform merge module 350 also serves for storing the modified baseline set of user profile objects to the production platform datastore 343. It should be noted that the contents of the production platform datastore 343, and/or the contents of the experimentation platform datastore 363 may comprise any sorts of data even other than user profile objects. For example, such datastores may be used conveniently to store experiment statistics, and/or comparisons of the operations and results of one experiment (e.g. Experiment_{—}1 364) as compared to a second experiment (e.g. Experiment_{—}2 365), etc.

Of course, at any point or points during the running of the experiments, a log of modifications made to the modified baseline set of user profile objects might be captured, possibly using the facilities of a cockpit 380, which in turn might store such a log to a local non-volatile storage (e.g. to an experimentation platform datastore 363), or might store elsewhere (e.g. to a production platform datastore 343) for forwarding via network 130.

Returning to the discussion of changes made to the modified baseline set of user profile objects, any one or more of the modules within the experimentation platform might serve for tagging at least one user event so as to be distinguishable from user events that are not tagged. In fact the tagging might be quite sophisticated, possibly depending in part on the configuration of an offramp 312 for sending events to an event tagging module 314, which configuration of an offramp might include filtering for selecting only certain types of user events, and which configuration of an offramp might include configuration from a configuration profile 316.

Some embodiments, and in particular, embodiments containing a cockpit 380, might also contain one or more real-time modules for monitoring operations and for logging modifications made to the modified baseline set of user profile objects. A cockpit 380, might also contain one or more real-time modules for processing any monitoring operations performed by a monitoring_P module 346, and/or from a monitoring_E module 366. In this manner, the likelihood that a user profile object might be modified, given some particular type or types of traffic (e.g. user events) may be captured and used in assessments of the effects of the experiments. Such one or more real-time modules for monitoring operations and for logging modifications made to the modified baseline set of user profile objects might further be used to signal to a inter-platform merge module 350 to commence any operation for merging or synchronizing operations other modifications made to the experimentation platform datastore 363, thus updating the production platform datastore 343.

### Extensible System for Large-Scale User Modeling Experiments Using Real-Time Traffic

The above-described environment 300 (as described in FIG. 3A, and in FIG. 3B) might be made extensible in a variety of ways, including use of services and/or application programming interfaces (APIs) and/or plug-ins. Any number of services, APIs and/or plug-ins may be defined for various purposes. Moreover, data structures present in the experimentation platform 360 might be modified, even to the point of being extended or augmented as compared to the corresponding data structure used in the production platform.

FIG. 4A depicts an exemplary extensible data structure showing one of a plurality of modified user profile objects 400, according to one embodiment. As an option, the present modified user profile objects 400 may be implemented in the context of the architecture and functionality of the embodiments described herein. Of course, however, the modified user profile objects 400 or any structure therein may be carried out in any desired environment. An exemplary modified user profile object 400 might comprise one or more modified user profile descriptors 410₀-410_{N}, which in turn may contain or be associated with one or more modified static attribute descriptors 420₀-420_{N}, one or more modified dynamic attribute descriptors 430₀-430_{N}, one or more modified short-term score descriptors 440₀-440_{N}, one or more modified long-term score descriptors 450₀-450_{N}, one or more modified user profile descriptor labels 460₀-460_{N}, and one or more modified user profile extensible fields 470₀-470_{N}. As will be recognized by one skilled in the art, an extensible modified user profile object 400 might comprise arbitrarily complex modified user profile extensible fields 470₀-470_{N}, or any one or more modified user profile extensible fields 470₀-470_{N} might be merely a memory pointer to one or more elsewhere located arbitrarily complex modified user profile extensible fields.

FIG. 4B depicts exemplary operations for initializing an extensible data structure and for merging a user profile object. As an option, the present environment 450 may be implemented in the context of the architecture and functionality of the embodiments described herein. Of course, however, the environment 450 or any structure or operation therein may be carried out in any desired environment. As shown, user profile objects (e.g. UO 342 and UO 362) might be co-located into a commonly accessible storage space 370 for use during concurrent operation of the production platform 340 and the experimentation platform 360. Strictly as an example, UO 342 might be embodied as a populated user profile object 200. Similarly, again strictly as an example, UO 362 might be embodied as a populated modified user profile object 400. In fact, and as depicted, the UO 362 might be allocated and/or populated via operations performed by a user profile object merge module 375 (see FIG. 3A). More particularly, a user profile object merge module 375 may perform operations on or for data, for example a data construction operation (see operation 482), and/or a data filtering operation for data (see operation 484), and/or a data splitting operation (see operation 486). Additionally, a user profile object merge module 375 might populate a UO 362 by allocating and populating via an allocation and population module 488. As may be understood by those skilled in the art, data present in a user object may take on values dynamically. That is, they may vary over time. Moreover, some techniques for matching a display advertisement to a user might use data that has been collected over a period of time. In such a situation and, in particular, when performing an experiment that relies on some time-based state of data in a user profile object, it is effective to capture such data over time, even before commencing with the matching portions of such an experiment. Accordingly, a user profile object merge module 375 might direct modules (e.g. traffic router 367, Experiment_{—}1 364, etc) within the experimentation platform 360 to collect data over time, and to populate a UO 362 using experimental results.

Also shown in FIG. 4B are checkboxes, which checkboxes are indicated next to corresponding data fields. At such time as an experiment is deemed to have been completed, the data collected over the duration of the experiment might be merged into a commonly accessible storage space 370 for further processing (e.g. by the production platform 340). In generalized terms, a merging operation might be described as (a) merging a first portion of a user profile object for use during continued operation of the production platform and, (b) selecting a second portion of a user profile object for discard (thus completing the experiment non-destructively).

Of course any combinations of merging a first portion of a user profile object and selecting a second portion of a user profile object may be performed. As shown by the checkboxes in FIG. 4A, the checked checkboxes correspond to merged fields “R_{1P}”, “MR₂”, “N₁R₃”, “N₂R₃”, and “R₄*”. And, as shown by the un-checked checkboxes, the data of “R₂”, “R₃”, “R₄”, and “R_{1E}” are discarded. Of course the checks and checkboxes are for illustrative purposes, and so such checkbox need appear in any particular embodiment. Yet, observing this paradigm, the merging operations can be described as merging a first portion of the user profile object (e.g. those portions corresponding to checked checkboxes) for use during continued operation of the production platform, and selecting a second portion of the user profile object (e.g. those portions corresponding to unchecked checkboxes) for non-destructive discard.

Such merge and discard operations results in the extensible user profile object 490, as shown.

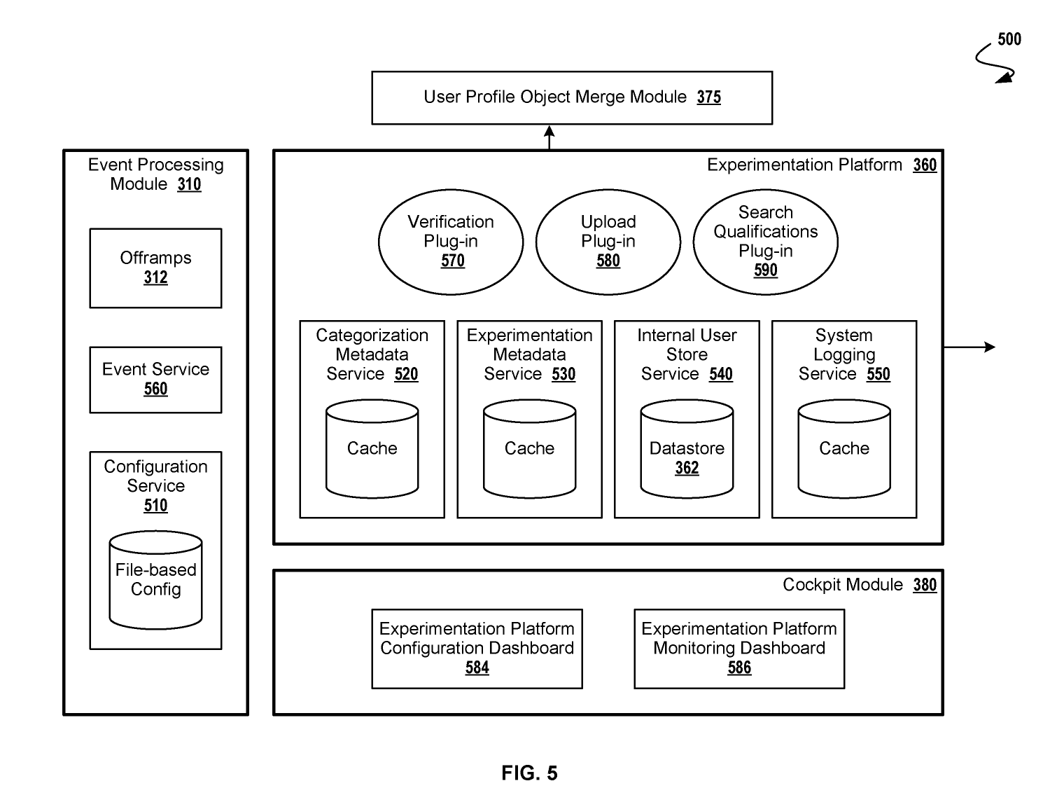

FIG. 5 depicts a block diagram of an extensible system for large-scale user modeling experiments using real-time traffic. As an option, the present system 500 may be implemented in the context of the architecture and functionality of the embodiments described herein. Of course, however, the system 500 or any structure or any operation therein may be carried out in any desired environment. As shown, system 500 includes an event processing module 310, an experimentation platform 360, a user profile object merge module 375, a cockpit module 380, and other components. The system 500 might be made extensible in a variety of ways, including use of services and application programming interfaces (APIs). Any number of services and APIs may be defined for various purposes. For example, one or more services and/or APIs might be defined as follows:
Configuration Service 510 and API: Provides access to configuration files and configuration metadata.
Categorization Metadata Service 520 and API: Provides access to features, categories, their weights and other metadata.
Experimentation Metadata Service 530 and API: Provides access to experimentation metadata, e.g. thresholds, decays, constants, etc.
Internal User Store Service 540 and API: Provides read and write access to the experimentation platform datastore.
System Logging Service 550 and API: System logging for debugging or other capture of system issues.
Event Service 560 and API: Provides mechanism for configuring an offramp for filtering or labeling purposes.

Any number of plug-ins may be defined for various purposes. For example, one or more plug-ins might be defined as follows:
Verification Plug-in 570
Upload Plug-in 580
Search Qualifications Plug-in 590

Thus, using any portions or combinations of the embodiments of environment 300 and/or system 500, the systems provide the ability to:
Schedule and quickly deploy bucket tests with arbitrary models.
De-couple (and re-couple) an experimentation platform environment from a production platform, while not sacrificing confidence that a particular experiment has run successfully. That is, a verification plug-in 570 might serve to bridge and collate traffic being processed (possibly concurrently) by both the production platform and the experimentation platform.
Reduce the risk of disrupting the production platform.
Improve recoverability, even after an experiment has been deemed failed.
Rapidly prototype display advertising modeling techniques in order to try different models in the experimentation platform.
Rapidly prototype user profile object modeling techniques in order to try different data structures in the experimentation platform, while not sacrificing the ability to upload modified user profiles to the production platform. That is, an upload plug-in 580 might serve to facilitate the storing of the modified baseline set of user profile objects to the production platform upon experiment completion (or even during experiment processing).
Control access to a set of user events.
Run multiple experimentation models concurrently.
Prime user profile data structures, possibly via an offline process. For example, some search experiments might require sufficient data to be collected in order for the experiment to be statistically meaningful, and such data collection might take many days (or longer) for the search experiments to accumulate meaningful reach. Thus a search qualification plug-in 590 might serve to collect data (possibly offline, not involving the experimentation platform) and, at some later point in time, the search qualification plug-in might upload to the experimentation platform datastore 362 to ‘bootstrap’ or ‘prime’ the data.
Log detailed experimentation results and capture, and possibly store, raw or processed relevant metadata

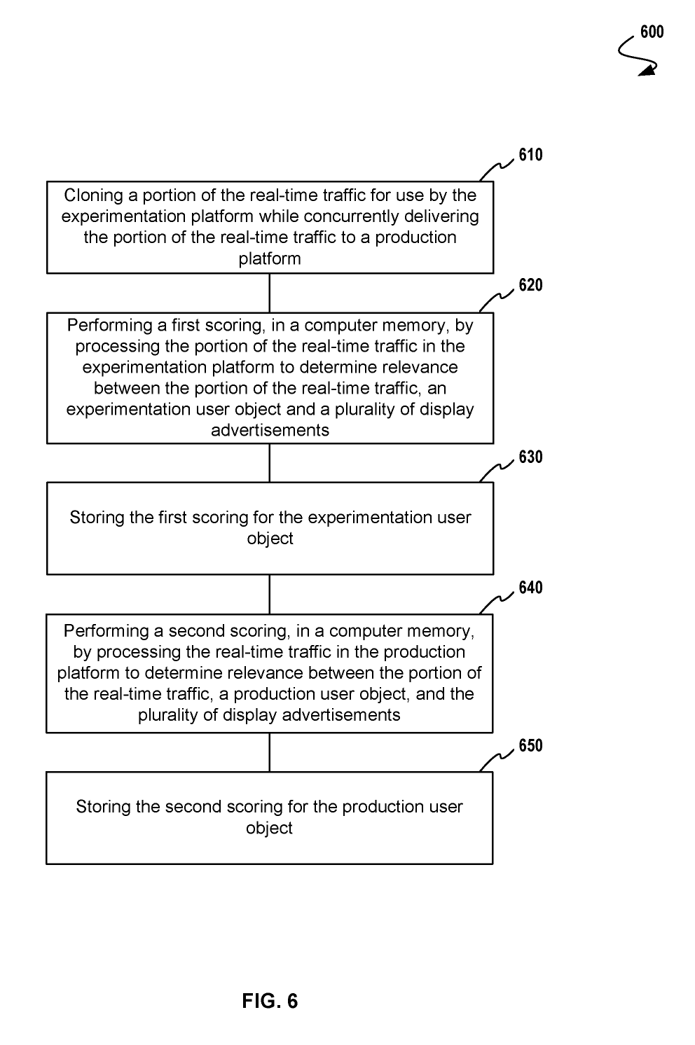

FIG. 6 depicts a block diagram of a method for matching a display advertisement to a user within a large-scale, non-destructive user modeling and experimentation environment using real-time traffic. As an option, the present method 600 may be implemented in the context of the architecture and functionality of the embodiments described herein. Of course, however, the method 600 or any operation therein may be carried out in any desired environment. The operations of the method can, individually or in combination, perform method steps within method 600. Any method steps performed within method 600 may be performed in any order unless as may be specified in the claims. As shown, method 600 implements a method for matching a display advertisement (e.g. display advertisement database 341 or display advertisement database 361) to a user, the method 600 comprising operations for: cloning a portion of the real-time traffic (e.g. traffic through the path 321) for use by the experimentation platform 360 while concurrently delivering the portion of the real-time traffic (e.g. the traffic through the path 321 also through the path 322) to a production platform 340 (see operation 610); performing a first scoring, in a computer memory, by processing the portion of the real-time traffic in the experimentation platform 360 to determine relevance between the portion of the real-time traffic, an experimentation user object (e.g. experimentation user object UO 362, wherever located) and a plurality of display advertisements (e.g. 361 or 341) (see operation 620); storing the first scoring for the experimentation user object (see operation 630); performing a second scoring, in a computer memory, by processing the real-time traffic in the production platform to determine relevance between the portion of the real-time traffic, a production user object (e.g. production user object UO 342, wherever located), and the plurality of display advertisements (e.g. 361 or 341) (see operation 640); and storing the second scoring for the production user object (see operation 650).

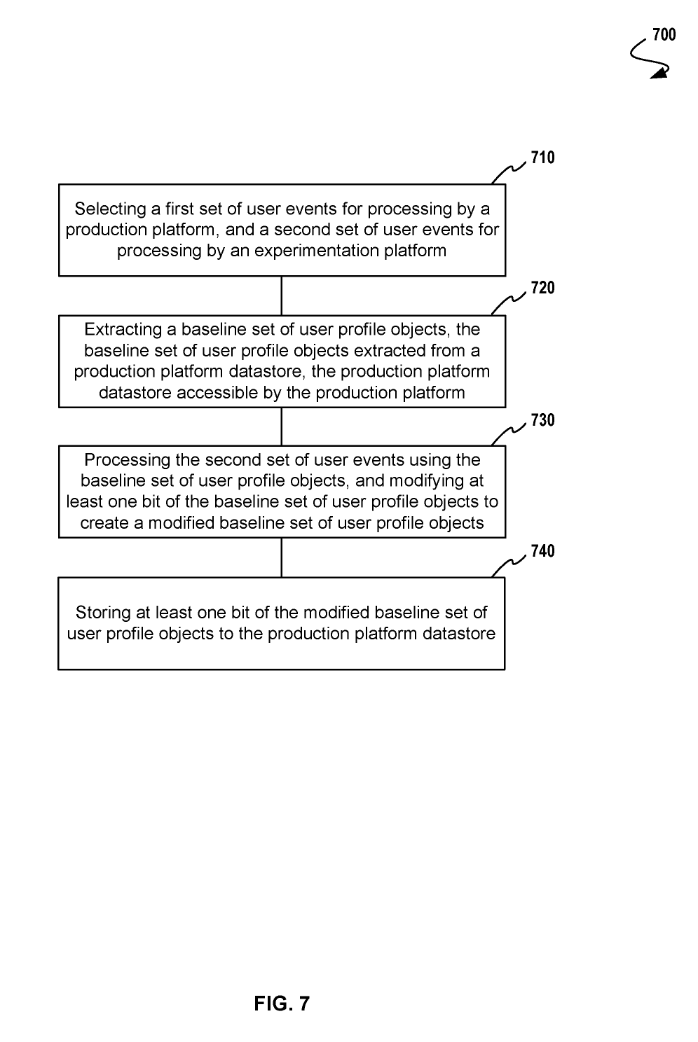

FIG. 7 depicts a block diagram of a method for large-scale user modeling experiments using real-time traffic. As an option, the present method 700 may be implemented in the context of the architecture and functionality of the embodiments described herein. Of course, however, the method 700 or any operation therein may be carried out in any desired environment. Any method steps performed within method 700 may be performed in any order unless as may be specified in the claims. As shown, method 700 implements a method for large-scale user modeling experiments using real-time traffic, the method 700 comprising operations for: selecting a first set of user events for processing by a production platform, and a second set of user events for processing by an experimentation platform (see operation 710); extracting a baseline set of user profile objects, the baseline set of user profile objects extracted from a production platform datastore, the production platform datastore accessible by the production platform (see operation 720); processing the second set of user events using the baseline set of user profile objects, modifying at least one bit of the baseline set of user profile objects to create a modified baseline set of user profile objects (see operation 730); and storing at least one bit of the modified baseline set of user profile objects to the production platform datastore (see operation 740).

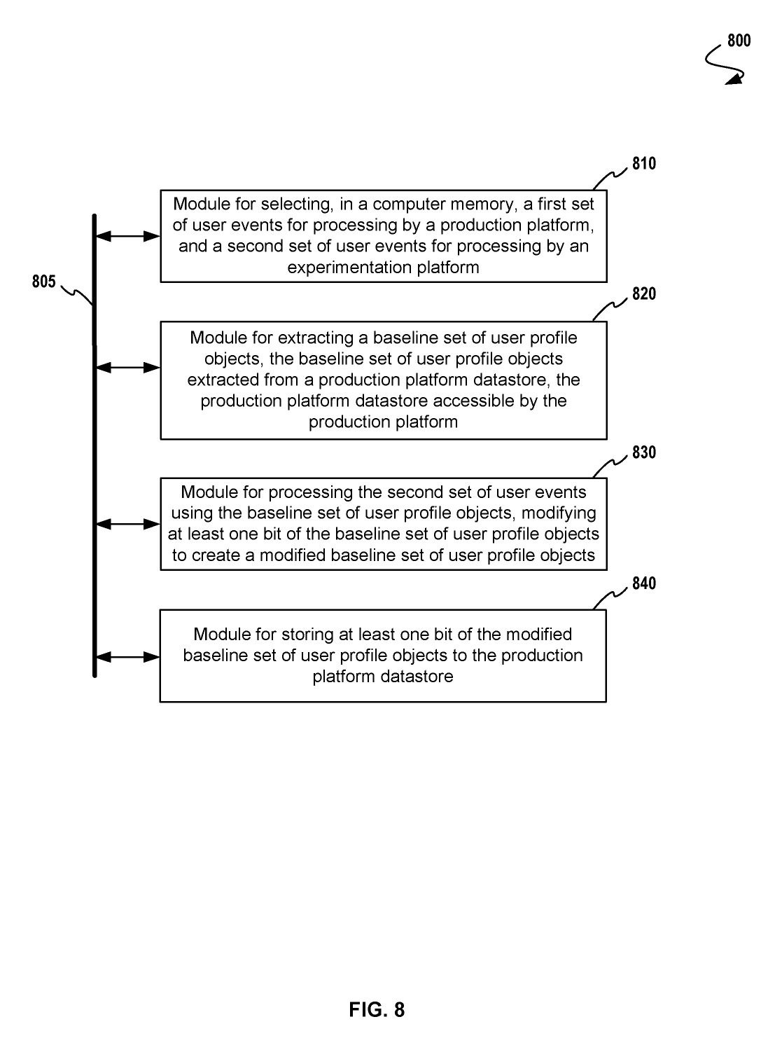

FIG. 8 depicts a block diagram of a system to perform certain functions of an advertising server network. As an option, the present system 800 may be implemented in the context of the architecture and functionality of the embodiments described herein. Of course, however, the system 800 or any operation therein may be carried out in any desired environment. As shown, system 800 comprises a plurality of modules including a processor and a memory, each module connected to a communication link 805, and any module can communicate with other modules over communication link 805. The modules of the system can, individually or in combination, perform method steps within system 800. Any method steps performed within system 800 may be performed in any order unless as may be specified in the claims. As shown, FIG. 8 implements an advertising server network as a system 800, comprising modules, with at least one module having a processor and memory, and including a module for selecting, in a computer memory, a first set of user events for processing by a production platform, and a second set of user events for processing by an experimentation platform (see module 810); a module for extracting a baseline set of user profile objects, the baseline set of user profile objects extracted from a production platform datastore, the production platform datastore accessible by the production platform (see module 820); a module for processing the second set of user events using the baseline set of user profile objects, modifying at least one bit of the baseline set of user profile objects to create a modified baseline set of user profile objects (see module 830); and a module for storing at least one bit of the modified baseline set of user profile objects to the production platform datastore (see module 840).

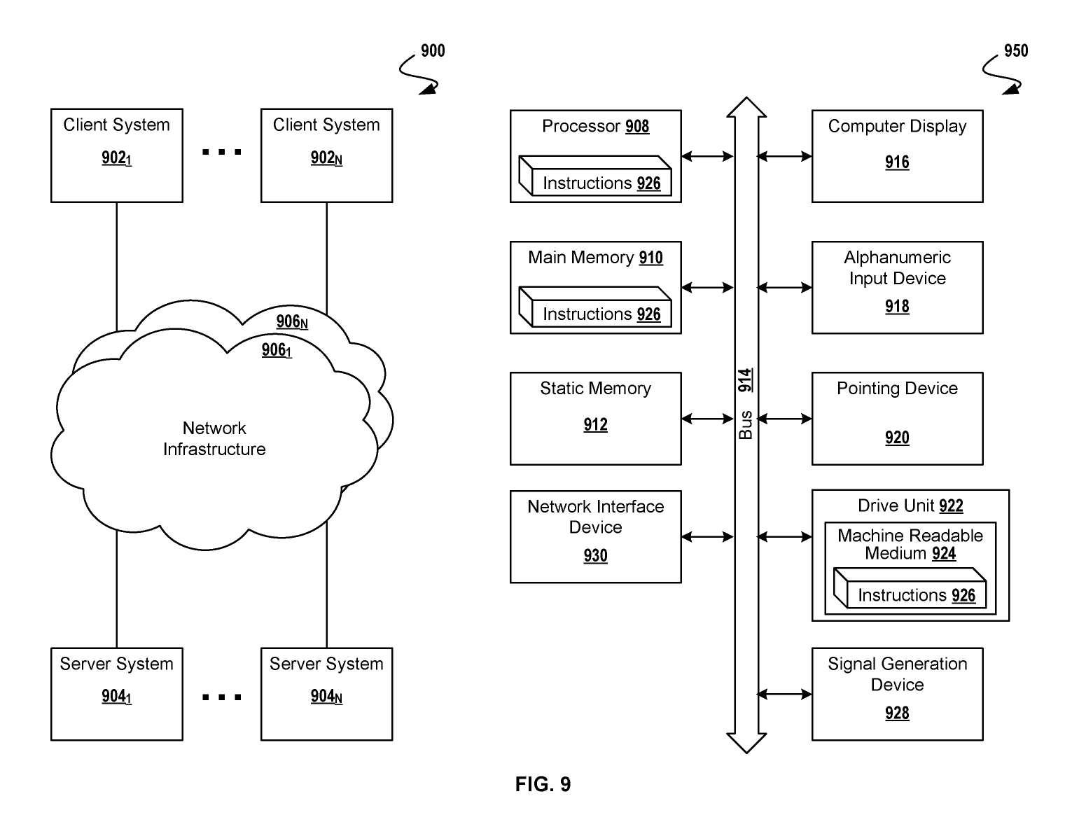

FIG. 9 is a diagrammatic representation of a network 900, including nodes for client computer systems 902₁ through 902_{N}, nodes for server computer systems 904₁ through 904_{N}, nodes for network infrastructure 906₁ through 906_{N}, any of which nodes may comprise a machine 950 within which a set of instructions for causing the machine to perform any one of the techniques discussed above may be executed. The embodiment shown is purely exemplary, and might be implemented in the context of one or more of the figures herein.

Any node of the network 900 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 950 includes a processor 908 (e.g. a processor core, a microprocessor, a computing device, etc), a computer memory (e.g. main memory 910) and/or a static memory 912), which communicate with each other via a bus 914. The machine 950 may further include a display unit 916 that may comprise a touch-screen, or a liquid crystal display (LCD), or a light emitting diode (LED) display, or a cathode ray tube (CRT). As shown, the computer system 950 also includes a human input/output (I/O) device 918 (e.g. a keyboard, an alphanumeric keypad, etc), a pointing device 920 (e.g. a mouse, a touch screen, etc), a drive unit 922 (e.g. a disk drive unit, a CD/DVD drive, a tangible computer readable removable media drive, an SSD storage device, etc), a signal generation device 928 (e.g. a speaker, an audio output, etc), and a network interface device 930 (e.g. an Ethernet interface, a wired network interface, a wireless network interface, a propagated signal interface, etc).

The drive unit 922 includes a machine-readable medium 924 on which is stored a set of instructions (i.e. software, firmware, middleware, etc) 926 embodying any one, or all, of the methodologies described above. The set of instructions 926 is also shown to reside, completely or at least partially, within the main memory 910 and/or within the processor 908. The set of instructions 926 may further be transmitted or received via the network interface device 930 over the network bus 914.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for matching a display advertisement to a user within a large-scale, non-destructive user modeling and experimentation environment using real-time traffic comprising:
cloning a portion of the real-time traffic for use by the experimentation platform while concurrently delivering said portion of the real-time traffic to a production platform;
performing a first scoring, in a computer memory, by processing the portion of the real-time traffic in the experimentation platform to determine relevance between the portion of the real-time traffic and a plurality of display advertisements;
storing the first scoring for an experimentation user object;
performing a second scoring, in a computer memory, by processing the real-time traffic in the production platform to determine relevance between the portion of the real-time traffic and the plurality of display advertisements; and
storing the second scoring for a production user object.

2. The method of claim 1, further comprising merging at least a portion of the experimentation user object with the production user object.

3. The method of claim 1, wherein the processing the portion of the real-time traffic in the experimentation platform comprises a configuration profile, the configuration profile for controlling user experimentation user object operations.

4. The method of claim 1, wherein the cloning comprises an offramp, the offramp for filtering only selected types of user events.

5. The method of claim 1, wherein performing the first scoring comprises a monitoring operation for logging modifications made to the production user profile object.

6. The method of claim 1, wherein performing the second scoring comprises a monitoring operation for logging modifications made to the experimentation user profile object.

7. A computer-implemented method for large-scale user modeling using real-time traffic comprising:
selecting, in a computer memory, a first set of user events for processing by a production platform, and a second set of user events for processing by an experimentation platform;
extracting a baseline set of user profile objects, the baseline set of user profile objects extracted from a production platform datastore, the production platform datastore accessible by the production platform;
processing the second set of user events using the baseline set of user profile objects, modifying at least one bit of the baseline set of user profile objects to create a modified baseline set of user profile objects; and
storing at least one bit of the modified baseline set of user profile objects to the production platform datastore.

8. The method of claim 7, further comprising:
storing, in a computer memory, a log of modifications made to the modified baseline set of user profile objects.

9. The method of claim 7, further comprising:
tagging, in a computer memory, at least one user event from the second set of user events.

10. The method of claim 7, wherein the selecting comprises an offramp, the offramp for filtering only selected types of user events.

11. The method of claim 7, wherein the selecting comprises a configuration profile, the configuration profile for tagging only selected types of user events.

12. The method of claim 7, wherein the extracting comprises a configuration profile, the configuration profile for tagging only selected types of user events.

13. The method of claim 7, wherein the processing comprises a monitoring operation for logging modifications made to the modified baseline set of user profile objects.

14. The method of claim 7, wherein the storing comprises a merging operation for merging modifications made to the experimentation platform datastore to the production platform datastore.

15. An advertising server network for large-scale user modeling using real-time traffic comprising:
a module for selecting, in a computer memory, a first set of user events for processing by a production platform, and a second set of user events for processing by an experimentation platform;
a module for extracting a baseline set of user profile objects, the baseline set of user profile objects extracted from a production platform datastore, the production platform datastore accessible by the production platform;
a module for processing the second set of user events using the baseline set of user profile objects, modifying at least one bit of the baseline set of user profile objects to create a modified baseline set of user profile objects; and
a module for storing at least one bit of the modified baseline set of user profile objects to the production platform datastore.

16. The advertising server network of claim 15, further comprising:
storing, in a computer memory, a log of modifications made to the modified baseline set of user profile objects.

17. The advertising server network of claim 15, further comprising:
tagging, in a computer memory, at least one user event from the second set of user events.

18. The advertising server network of claim 15, wherein the selecting comprises an offramp, the offramp for filtering only selected types of user events.

19. The advertising server network of claim 15, wherein the selecting comprises a configuration profile, the configuration profile for tagging only selected types of user events.

20. The advertising server network of claim 15, wherein the extracting comprises a configuration profile, the configuration profile for tagging only selected types of user events.
